(19) United States
(12) Patent Application Publication
(10) Pub. No.: US 2017/0016933 A1
(43) Pub. Date: Jan. 19, 2017

(54) SCANNING ION CONDUCTANCE MICROSCOPY

(71) Applicant: OPENIOLABS LTD, Cambridge (GB)

(72) Inventor: Andrew James Richardson, Chippenham Cambridgeshire (GB)

(21) Appl. No.: 15/124,908

(22) PCT Filed: Mar. 10, 2015
(86) PCT No.: PCT/GB2015/050688

§ 371 Date: Sep. 9, 2016

(30) Foreign Application Priority Data
Mar. 10, 2014 (GB) 1404145.3
Apr. 2, 2014 (GB) 1405900.0

(51) Int. Cl. G01Q 60/44; G01Q 10/02; G01Q 60/02; G01Q 10/06; G01Q 60/60

(52) U.S. Cl. CPC G01Q 60/44; G01Q 10/06; G01Q 60/60; G01Q 60/02; G01Q 10/02

(57) ABSTRACT

A method for interrogating a surface of a sample bathed in electrolyte solution using SICM, comprising: controlling the potential between first and second electrodes bathed in the electrolyte solution to induce an ion current in the electrolyte solution, a submerged portion of the first electrode being contained within a micropipette and the second electrode being external to the micropipette; recording the ion current whilst controlling the micropipette to move with respect to a stage supporting the sample; and determining, from the ion current and calibration data, the surface height profile of the sample. Said potential can be controlled according to a spread spectrum modulated signal. Said micropipette motion can be according to an AC mode pattern having a modulation frequency greater than a resonant frequency of an assembly of the micropipette, first electrode and a first piezoelectric actuator configured to control z-axis motion of said micropipette.

This disclosure relates to scanning ion conductance microscopy (SICM), and increasing efficiency and accuracy in its use e.g. in the study of soft surfaces and interfaces, including those of cells and convoluted matrix structures. Improvements to combined SICM and scanning electrochemical microscopy (SECM) techniques are also disclosed, for use e.g. in the study of chemical reactions occurring on hard surfaces.

Soft surfaces are a feature of many natural phenomena, particularly when immersed in liquid, including cell membranes and immiscible liquid droplets. The cell is the most fundamental unit of living organisms, whether animal or plant. The study of its structure and composition, and how its various constituents function, lends valuable insight into the complex processes which occur in integrated biological systems. This requires techniques which allow investigation of cell samples to be conducted in real-time, non-invasively, and in solutions that mimic physiological conditions so that cell functionality is retained.

Optical microscopy (using visible light) has been applied widely to study live cells. However, the resolution is limited by diffraction to about 200-250 nm. Many other imaging and measurement techniques employ a probing method that applies forces which may induce errors by disturbing the surface under observation or which require modification of the surface before such observation can be carried out.

For example, one commonly used method is electron microscopy, where it is possible to obtain images with 10 nm resolution. However, the need for a vacuum or low pressure gas may require stabilization of the surface and removal of liquid before imaging may be carried out. Hence, it is not generally possible to use an electron microscope to study living cells.

Another possible high resolution technique is based on the use of scanning probe microscopy (SPM), in which a sharp probe tip is scanned in close proximity to the sample under study. The consequent interactions and thus the chemical/physical properties of the sample can be plotted as a function of the tip's position with respect to the sample, to generate a profile of this measured interaction. Members of the SPM family that are commonly applied to biological imaging are atomic force microscopy (AFM) and scanning ion-conductance microscopy (SICM).

AFM is commonly used to study the response of a surface to mechanical force or pressure. An AFM consists of a cantilever with a sharp tip (probe) at its end which is used to scan the specimen surface. When the tip is brought into proximity with a sample surface, forces between the tip and the sample lead to a deflection of the cantilever. However, the tip cantilever spring constant affects how much the surface under study will be displaced by the measurement or detection process and sets a limit to the softness of a surface which can be studied. An additional difficulty with AFM, when used in contact or tapping mode, is the likelihood of the surface adhering to the probe tip, altering the measurements during retraction and leading to contamination of the tip and mechanical damage to the surface.

Scanning ion conductance microscopy (SICM) is a form of scanning probe microscopy (SPM) that allows the high resolution imaging of soft surfaces without any contact or force interaction whatsoever and in the normal liquid environment of the subject. In SICM, an electrolyte filled (typically glass, quartz or carbon-based) micropipette is scanned over the surface of a sample bathed in an electrolytic solution. SICM can be used effectively to scan the surface of e.g. a live cell by controlling the position of such a probe. An ion current is induced between two electrodes: one inside the pipette and another outside in the electrolyte solution.

The ion-current signal depends on a combination of the micropipette's resistance (R_{P}) and the access resistance (R_{AC}) which is the resistance along the convergent paths from the bath to the micropipette opening. R_{P} depends on the tip diameter and cone angle of the micropipette, whereas R_{AC} displays complicated dependence on the electrochemical properties of the bath and the sample, geometry and separation from the probe.

As the micropipette approaches the surface of the sample, the ion current flow changes from a relatively constant steady-state current and starts to reduce very quickly. The distance that the micropipette has to be from the sample for the ion current reduction is in the region of twice to half the inner diameter of the micropipette. For glass micropipettes this inner diameter can be as small as around 50 nm and for a quartz micropipette, the inner diameter can be as small as around 20 nm.

The optimum tip-sample separation that has allowed SICM to be established as a non-contact profiling method for elaborated surfaces is approximately one-half of the tip diameter. The spatial resolution achievable using SICM is dependent on the size of the micropipette tip aperture, and is typically between 50 nm and 1.5 μm.

By repeatedly bringing the micropipette into contact with the surface at adjacent locations a 3D topographic map or image of the surface can be formed.

SICM systems can operate in a number of modes, including hopping mode, alternating current (AC) mode and manual mode.

One of the most common scanning methods is referred to as the hopping mode raster scan. Typically, in this method, the location and height of the micropipette is controlled by a controller that sends signals to piezoelectric flexure stages that allow precise control of the X, Y and Z dimensions of the micropipette. The controller monitors the ion current, typically via a low-noise head stage.

The hopping mode raster scan is typically performed as follows. Starting at some origin, the micropipette is raised to a height (Z axis) that is regarded a-priori to be higher than any features of the sample. The micropipette is then lowered with a controller monitoring the ion current until a small drop in current is detected which indicates that the surface of the sample is close. The drop in current can vary, but will typically be in the region of 0.1% to 10% of the nominal steady state current. The controller will record the X, Y and Z location for the point, and then move the pipette back to a safe height before moving to the next X, Y location of a raster scan. The micropipette is then lowered, once again, to the surface and the X, Y, Z readings recorded by the controller. This process can continue until a complete scan of a region of the sample is made. Typically, a raster scan involving an array of 128 X locations and 128 Y locations is made, covering a sample area in the region of 10 μm².

Various improvements in the scanning algorithm have been proposed. For example, a first line of a raster scan can be performed at a high height (to avoid surface features) and then subsequent scans at a lower height based on the heights measured in the previous line scan. Alternatively, rather than scanning a line, the controller might select vertices of a rectangle. Depending upon a measure of the surface roughness for the rectangle (and thus its likely importance to the investigation being performed), either another rectangle is selected, or points within the first rectangle are selected for interrogation.

In AC mode a sinusoidal current is applied to a piezoelectric device for controlling the Z-axis location of the pipette. The pipette oscillates with a small amplitude over the surface of the sample. As the pipette approaches the surface of the sample, the ion current starts to vary at a rate that is proportional to the AC modulation of the pipette. A lock-in amplifier can be used to phase lock to the frequency of the Z-pipette modulation. The use of such an amplifier is very beneficial in terms of rejecting noise outside of the frequency band of the modulating signal.

With the pipette motion modulated using this AC-mode, the envelope of the AC current can be detected and used to detect the surface. Generally, the average location of the pipette from the surface is adjusted using the detected current envelope so that the pipette maintains a near constant distance from the sample. In this manner, the topography of the sample can be scanned using a raster scan mechanism in a similar manner to the hopping mode.

In all of these modes of operation, the pipette follows a similar procedure:
1. move to an XY location;
2. wait for a short period for mechanical oscillations of the micropipette to decay;
3. lower the micropipette slowly towards the sample surface whilst monitoring the current;
4. wait a short period for the mechanical oscillations of the micropipette to decay;
5. repeat steps 3 and 4 at the same XY location to arrive at a stable sample for the ion current;
6. raise the micropipette to a suitable safe height before moving to the next XY location and repeating from step 1.

The procedure outlined above provides a good accurate method for measuring the 3D topography of the sample, but includes many delays to allow mechanical oscillations to decay and also to allow the micropipette to rise up and down. The time taken for the image from a single point to be collected can often take many tens of milliseconds, and this results in the total scan time approaching tens of minutes for images of reasonable complexity. For some applications in which fast changes in the image are required, these scan times are unacceptably high. For example, living biological cells change their surface formation from time to time. Drifts and stitch effects have been observed between adjacent areas over the scanned living cell surface in images obtained from conventional SICM.

During the advance of the probe towards the surface, the motion of the probe may be halted after the current falls below a pre-set threshold for the first time, for a given time or for a given number of measurement samples. Such additional measurements provide information about the relationship between ion current and distance from the probe to the surface in the region close to that surface. The graphical representation of this relationship is commonly called an approach curve. This relationship may indicate characteristics of the surface, including its roughness, its conductivity relative to the surrounding solution, or the degree to which it is normal to the probe axis.

The reduction in ion current as the pipette (probe) approaches the surface can be used to determine information about the surface curvature and mechanical properties of the sample at this point. The shape of the reduction in current contains information about these additional properties of the surface, as well as topography. For example, if the surface is soft the pipette needs to move further down to get the same reduction in ion current since the surface moves away as the pipette approaches, due to forces exerted when the pipette is close to the surface. The pipette also needs to move further down if the surface is more curved. By analysing the approach curves and optionally doing the approach at the same place at different applied voltages, which will alter the force applied, it is possible to obtain additional information, and hence map these additional properties at the same time. It is therefore possible to map other surface properties as well as the sample topography. This may provide more contrast in the obtained image making certain features of interest easier to detect, e.g. an underlying cell cytoskeleton under a cell membrane.

SICM probes may be adapted such that, when located in proximity to the surface under study, a localised and controlled pressure or force can be applied to the measurement surface by means of a regulated flow of liquid through the probe. The application of this pressure can be used to measure the flexibility or elasticity of the surface by monitoring the relationship between the applied pressure and the resulting movement of the surface. It can also be used to stimulate cell surface components, e.g. mechanosensitive ion channels, with subsequent measurement of this stimulation carried out by monitoring consequent changes in electrophysiological or chemical signals.

The pressure applied to the surface will, if the surface is sufficiently pliable, cause the surface to move. Positive pressure, i.e. flow through the probe towards the surface, has the effect of pushing the surface away from the probe, increasing the separation between the surface and probe tip. A negative pressure draws the surface towards the probe tip, decreasing the separation. The relationship between the applied pressure and the resulting movement of the surface can therefore provide information on the elasticity of the surface structure.

Another application of a SICM system is to assist in the collection of ion current information according to the processes known as scanning electrochemical microscopy (SECM). SECM is a versatile tool for the electro-analytical measurement of electro chemical reactivity of samples based on the nature of the substance and the distance from the substance.

Traditionally, SECM uses a three-electrode system for a sample in an electrolyte solution. A working electrode is connected to the sample, a reference electrode in the electrolyte solution and a counter electrode in the form of a probe. The objective in a SECM system is to maintain a constant known potential between the working electrode and the reference electrode whilst measuring the redox activity of the sample by measuring the surface activity current between the counter electrode and the working electrode. A potentiostat is typically used to manage the required potentials whilst collecting the surface activity current.

Recently the attention of SECM has turned to the use of micropipettes to facilitate the measurement of the redox reactions between the sample and the micropipette or probe whilst using additional techniques such as AFM or SICM to measure and maintain a known distance between the probe and the sample surface.

One means of implementing combined SICM and SECM is using a double barrel pipette manufactured from theta capillaries. Very small dimensions for the apertures of these micropipettes can be obtained using laser pipette pullers, with aperture sizes in the region of 100 nm feasible. The current flow through a meniscus layer between the two barrels of the pipette is used by the SICM system to monitor the location of the pipette from the surface of the sample. The flow of the current from the counter electrode in the pipette and the working electrode is then recorded and is a measure of the redox activity of the sample. Combining SICM and SECM allows the SECM analysis of a sample to be spatially coordinated with features from the sample. The SICM system is used to generate the topography of the sample and used to guide the SECM micropipette to the locations of interest and collect the ion currents for the SECM system for further analysis.

A conventional deployment of SICM and SECM would typically require two micropipettes deployed in parallel. Whilst this approach is frequently used, it does lead to issues with the alignment of the micropipettes and achieving micropipettes that are in close proximity to one another.

As has been explained in the foregoing, what is needed is an enhanced SICM method and system which improves one or more of the speed, efficiency and accuracy of SICM techniques, whether used alone or in combination with SECM.

According to a first aspect, there is provided a method for interrogating a surface of a sample bathed in electrolyte solution using scanning ion conductance microscopy (SICM), comprising: controlling the potential between first and second electrodes bathed in the electrolyte solution to induce an ion current in the electrolyte solution using a spread spectrum modulated signal, a submerged portion of the first electrode being contained within a micropipette and the second electrode being external to the micropipette; recording the ion current whilst controlling the micropipette to move with respect to a stage supporting the sample; demodulating the recorded ion current; and determining, from the demodulated ion current and calibration data, the surface height profile of the sample.

Said spread spectrum modulation could comprise multiplexing a plurality of signals in the time or frequency domain.

Said spread spectrum modulation could be carried out by binary phase shift keying (BPSK). Said spread spectrum modulation could be carried out by quadrature phase shift keying (QPSK). Said spread spectrum modulation could be carried out by n-quadrature amplitude modulation (n-QAM). Said spread spectrum modulation could be carried out by frequency modulation (FM). Said spread spectrum modulation could be carried out by amplitude modulation (AM).

Said spread spectrum modulation could be performed on a predetermined carrier frequency. Said carrier frequency could be greater than 100 Hz.

Said spread spectrum modulation could be performed using orthogonal spreading codes. Said orthogonal spreading codes could be Walsh codes. Said orthogonal spreading codes could be orthogonal variable spreading factor (OVSF) codes.

Said spread spectrum modulation could be performed using 2 different spreading codes. Said spread spectrum modulation could be performed using 3 different spreading codes.

Said spread spectrum modulation could be performed using pseudo-random scrambling codes. Said pseudo-random scrambling codes could be Gold code sequences. Said pseudo-random scrambling codes could be m-sequences.

The method could further comprise filtering the recorded ion current. Said filtering could be done using a band pass filter.

The method could further comprise feeding back surface height profile data in order to control said micropipette motion to track the sample surface.

A surface tracking signal could be provided using a short correlator.

Said spread spectrum modulation could be performed using at least a first spreading code for surface tracking and a second spreading code for imaging. Said second code could be longer than said first code.

Said demodulation could be performed using a long correlator.

The method could further comprise executing a de-convolution algorithm to reduce image blurring caused by micropipette movement.

Said determination could comprise deconvolving the demodulated ion current with a truncated cone having the sample surface as its base and the micropipette aperture as its top.

The method could further comprise collecting data from a third electrode for scanning electrochemical microscopy (SECM).

The method could further comprise applying a direct current (DC) offset voltage to said third electrode relative to said first electrode.

A first piezoelectric actuator could be used for relatively fine z-axis motion control of the micropipette. A second piezoelectric actuator could be used for relatively coarse z-axis motion control of the sample stage.

Said micropipette motion could be according to a hopping mode pattern.

Said micropipette motion could be according to an alternating current (AC) mode pattern.

Said AC mode pattern could have a modulation frequency greater than a resonant frequency of an assembly of the micropipette, first electrode and a first piezoelectric actuator configured to control z-axis motion of said micropipette.

According to a second aspect there is provided a method for interrogating a surface of a sample bathed in electrolyte solution using AC mode scanning ion conductance microscopy (SICM), comprising: controlling a first piezoelectric actuator to vary the height of a micropipette containing a portion of a first electrode submerged in the electrolyte solution relative to a stage supporting the sample, using an alternating current (AC) of modulation frequency greater than the resonant frequency of an assembly of the actuator, micropipette and first electrode, in order to induce an ion current in the electrolyte solution between said first electrode and a second electrode external to the micropipette and bathed in the electrolyte solution; recording the ion current whilst controlling the micropipette to move with respect to the sample stage, said motion having a component perpendicular to the AC height variation; and determining, from the recorded ion current and calibration data, the surface height profile of the sample.

Said AC modulation frequency could be at least 20 times said resonant frequency.

Said AC modulation frequency could be approximately 60 kHz.

Prior to said recording, said AC mode motion could be switched on with an initial AC frequency lower than said AC modulation frequency, which is gradually turned up to said AC modulation frequency over a predetermined period of time according to a ramp function.

Said ramp function could be the inverse of a complex envelope of resonances of said assembly.

Said predetermined period could be approximately 3 ms.

The method could further comprise driving a second piezoelectric actuator to control z-axis motion of said sample stage according to a signal modulated by the magnitude of a complex envelope of the recorded ion current.

A voltage correction could be applied to a second piezoelectric actuator configured to control z-axis motion of said sample stage. Said voltage correction could scale linearly with the detected ion current.

A constant of proportionality for said scaling could be determined through a calibration process and/or from a predetermined constant associated with the electrolyte solution.

The bandwidth of a drive signal for a second piezoelectric actuator configured to control z-axis motion of said sample stage could be less than the resonant frequency of an assembly of said second piezoelectric actuator with the micropipette, sample stage, sample container, electrolyte and sample.

The method could further comprise controlling the potential between said first and second electrodes using a spread spectrum modulated signal. Said determining could comprise demodulating the recorded ion current.

Said spread spectrum modulation could comprise multiplexing a plurality of signals in the time or frequency domain.

Said spread spectrum modulation could be carried out by binary phase shift keying (BPSK). Said spread spectrum modulation could be carried out by quadrature phase shift keying (QPSK). Said spread spectrum modulation could be carried out by n-quadrature amplitude modulation (n-QAM). Said spread spectrum modulation could be carried out by frequency modulation (FM). Said spread spectrum modulation could be carried out by amplitude modulation (AM).

Said spread spectrum modulation could be performed on a predetermined carrier frequency. Said carrier frequency could be greater than 100 Hz.

Said spread spectrum modulation could be performed using orthogonal spreading codes. Said orthogonal spreading codes could be Walsh codes. Said orthogonal spreading codes could be orthogonal variable spreading factor (OVSF) codes.

Said spread spectrum modulation could be performed using 2 different spreading codes. Said spread spectrum modulation could be performed using 3 different spreading codes.

Said spread spectrum modulation could be performed using pseudo-random scrambling codes. Said pseudo-random scrambling codes could be Gold code sequences. Said pseudo-random scrambling codes could be m-sequences.

The method could further comprise filtering the recorded ion current, optionally using a band pass filter.

The method could further comprise feeding back surface height profile data in order to control said micropipette motion to track the sample surface.

A surface tracking signal could be provided using a short correlator.

Said spread spectrum modulation could be performed using at least a first spreading code for surface tracking and a second spreading code for imaging, said second code being longer than said first code.

Said demodulation could be performed using a long correlator.

The method could further comprise executing a de-convolution algorithm to reduce image blurring caused by micropipette movement.

Said determination could comprise deconvolving the demodulated ion current with a truncated cone having the sample surface as its base and the micropipette aperture as its top.

The method could further comprise collecting data from a third electrode for scanning electrochemical microscopy (SECM).

The method could further comprise applying a direct current (DC) offset voltage to said third electrode relative to said first electrode.

The first piezoelectric actuator could be used for relatively fine z-axis motion control of the micropipette. A second piezoelectric actuator could be used for relatively coarse z-axis motion control of the sample stage.

Said calibration data could comprise a composite approach curve for each XY location at which the ion current is recorded. Said composite approach curves could be determined from a plurality of calibration approach curves measured during a training sequence.

Said composite approach curves could be linear combinations of said plurality of calibration curves weighted according to the linear distances of said respective XY locations from the XY locations of said plurality of calibration curves.

Said plurality of calibration curves could be collected prior to and/or during and/or after said step of recording the ion current whilst controlling the micropipette to move with respect to the sample stage.

Aspects of the present invention will now be described by way of example with reference to the accompanying figures. In the figures:

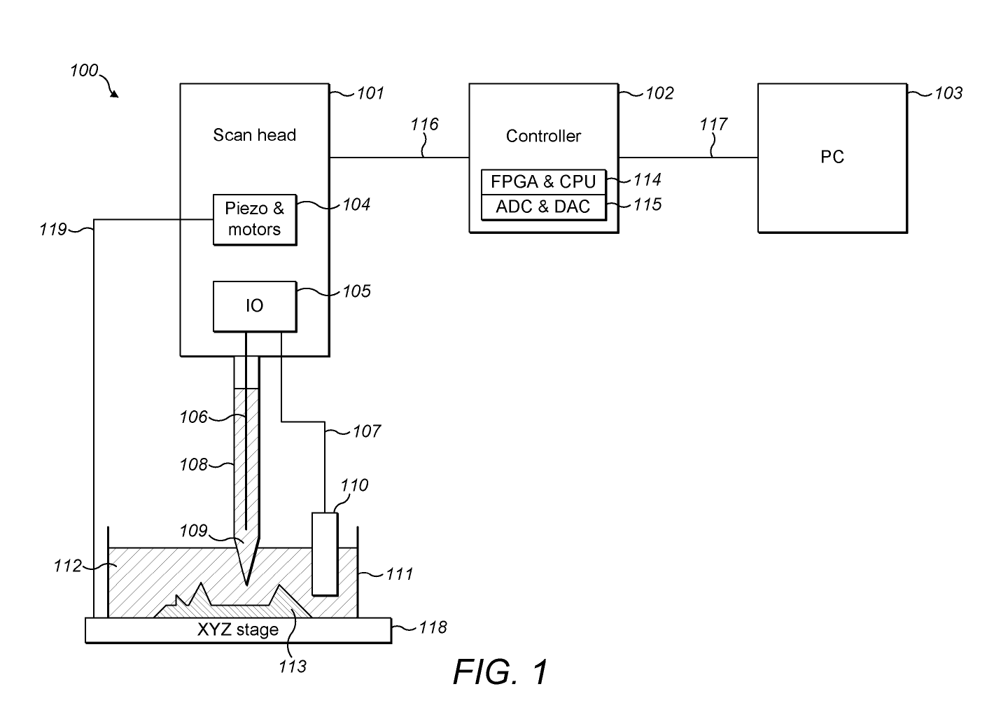

FIG. 1 illustrates an example SICM system;

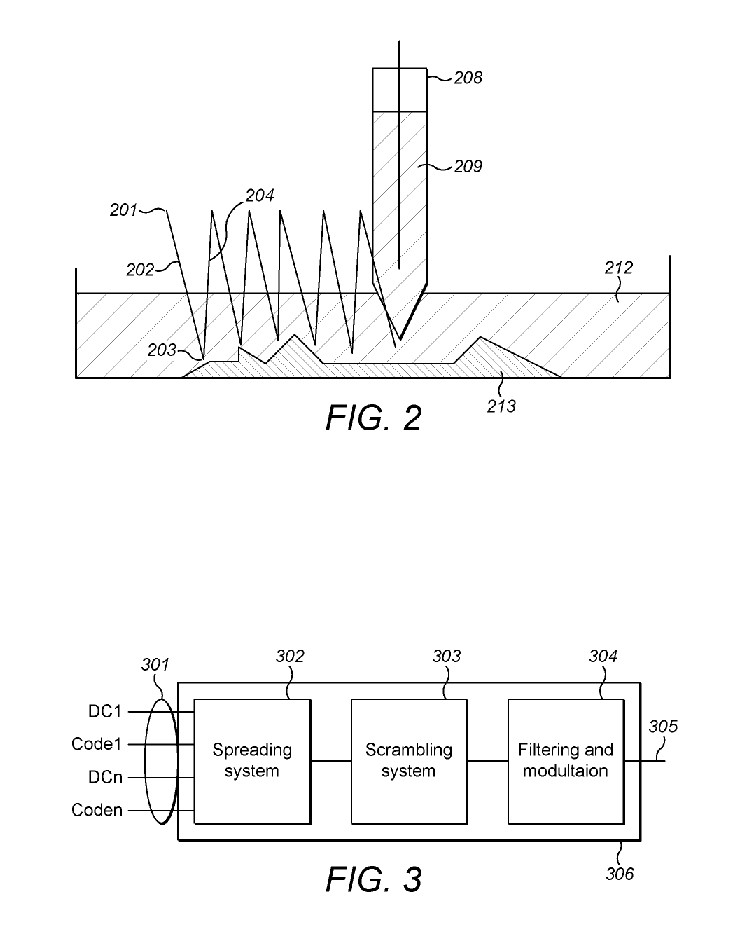

FIG. 2 illustrates the raster scan hopping mode;

FIG. 3 is a schematic illustration of a spreading, scrambling and modulation system;

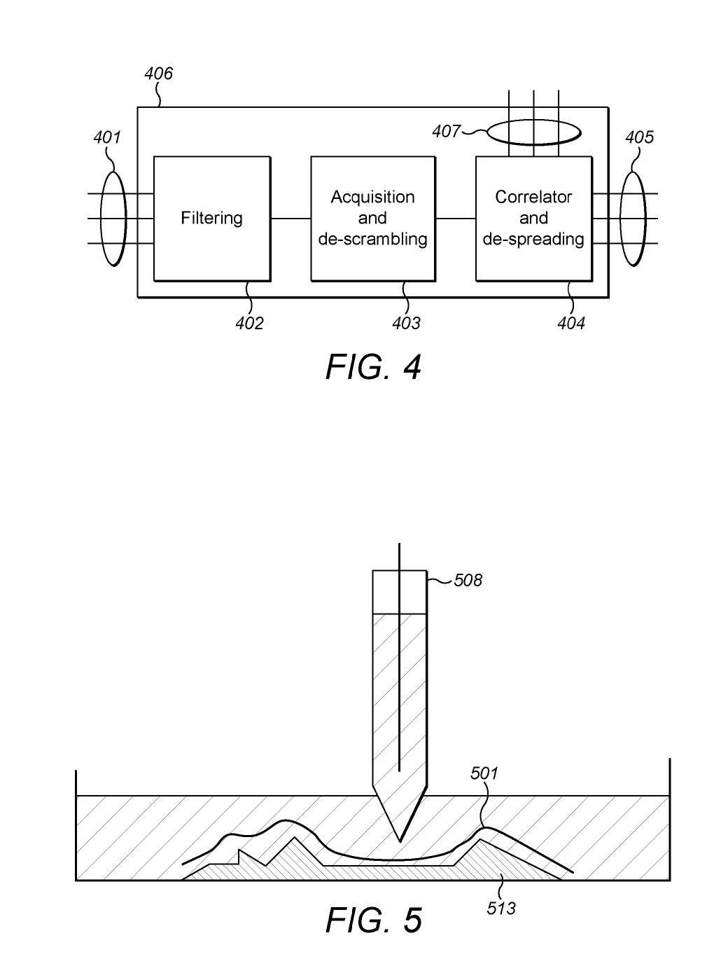

FIG. 4 is a schematic illustration of an example demodulator;

FIG. 5 illustrates the tracking mode;

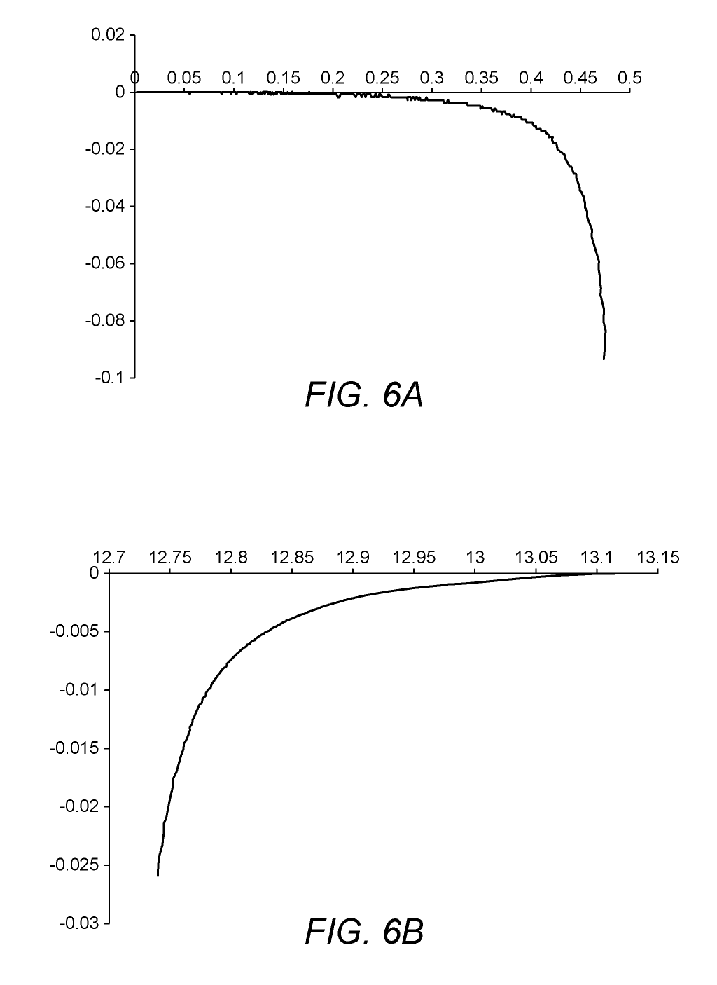

FIGS. 6A and 6B show example approach curves;

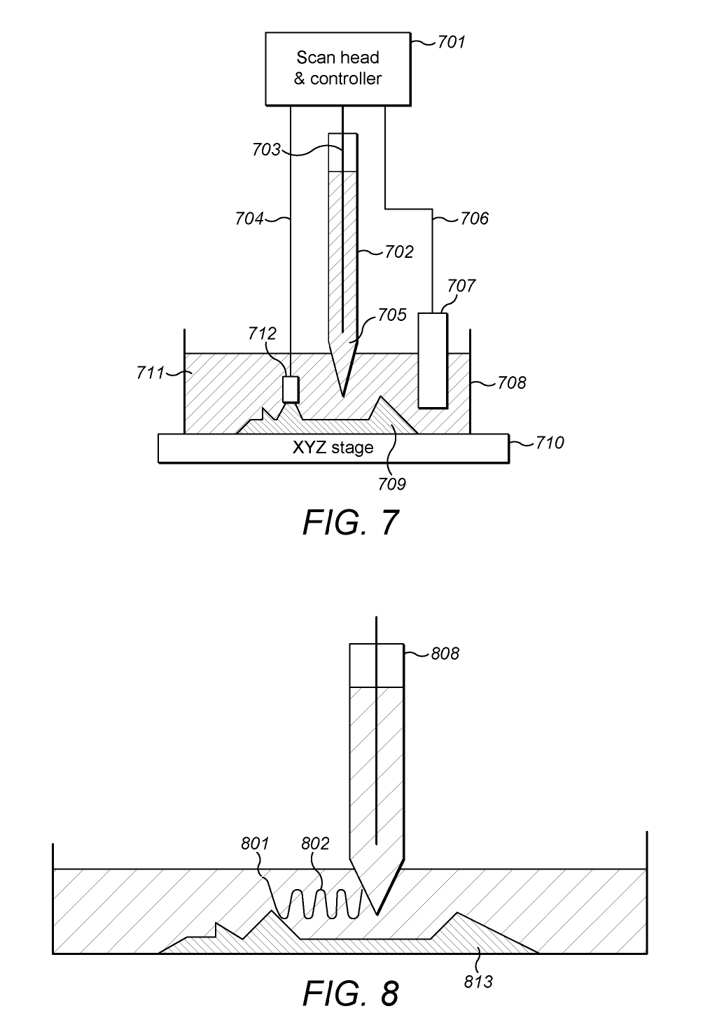

FIG. 7 illustrates an example combined SECM and SICM system;

FIG. 8 illustrates the raster scan AC mode;

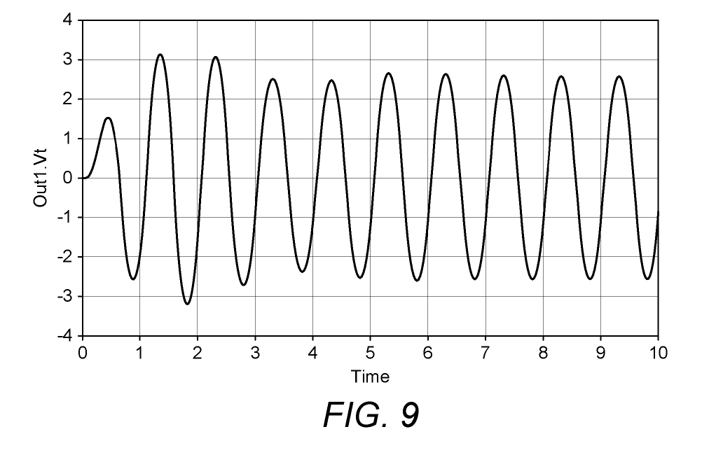

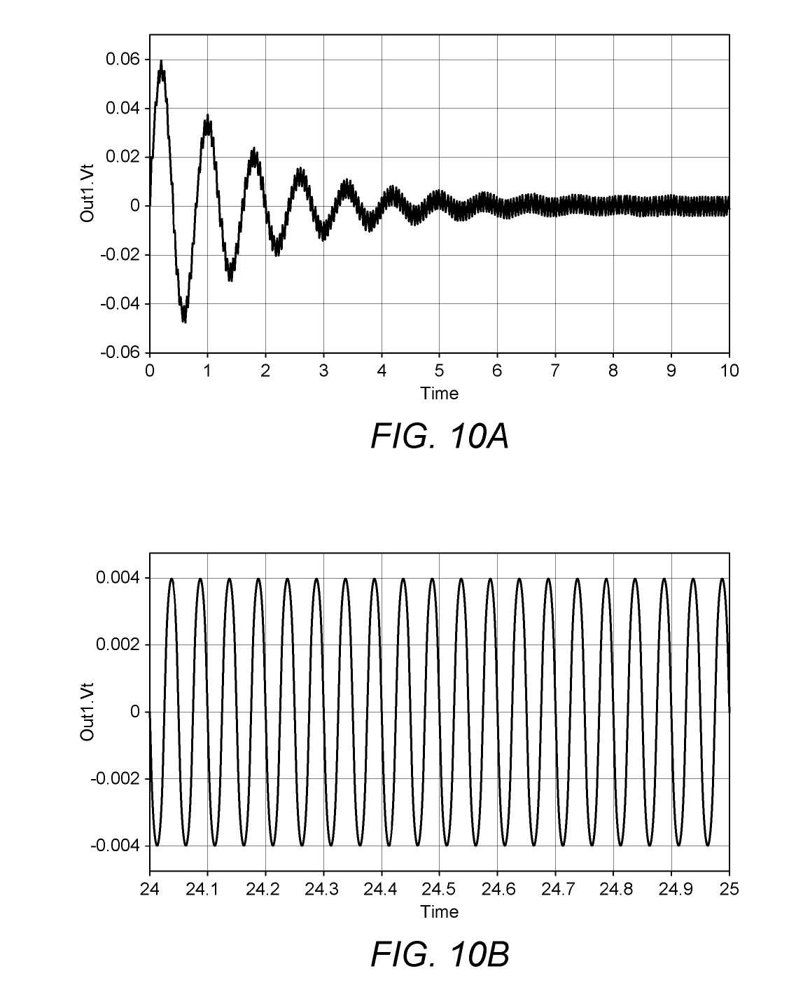

FIGS. 9, 10A and 10B show AC mode responses.

The following description is presented to enable any person skilled in the art to make and use the system, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The term ‘interrogate’ is intended to refer to the ability to monitor changes at the surface of a structure, e.g. to detect structural changes on or at the surface at a single position or as the probe scans the surface, or to measure the height of a structure. In certain circumstances the surface may be pliable, and allow imaging of structures underneath the surface, e.g. cytoskeleton underneath a cell surface. This is included in the term. It is not intended that the term be restricted to detecting structural changes, and the monitoring of, for example, electrophysiological or chemical changes is also included.

The term “pixel” as used herein refers to a measured and processed data point at a specific location. The number of pixels in a scan can be selected by a user of the system.

An example SICM system 100 shown in FIG. 1 comprises a scan head 101 a controller 102 and a PC 103. The scan head preferably contains the electronics and motors to amplify weak ion currents and move both a pipette 108 and a sample container (e.g. petri dish) 111. The scan head can include piezoelectric actuators and motors 104. The piezo actuators may operate in XYZ axes with movement resolution in the region of 1 nm or better and a travel range of typically 100 μm. The motors (e.g. direct current, DC, motors) can be used as coarse positioning devices and will position both the pipette 108 and the sample holder 111 to accuracies in the order of 1 μm and over travel ranges in the order of 20 mm.

Scan head 101 includes input/output (IO) electronics 105 e.g. amplifiers and filters to amplify and filter signals.

The pipette 108 can be attached to the scan head in a manner that will allow the XYZ location of the pipette tip to be controlled by both the piezo stages and the coarse motor stages 104. In a preferred embodiment, the piezo stages and the coarse motor stages will also include servo systems that measure the location of the sample holder 111 and the pipette 108. The servo measured locations and the actual commanded locations can be used in a feedback system to ensure that both the pipette and the sample holder locations are accurately known. The pipette is filled with some electrolyte solution 109 and includes an electrode 106 connected to the IO stages 105.

Within the sample holder 111 there is a sample 113 to be measured, a second electrode 110 and electrolyte liquid 112. The sample holder can sit on an XYZ stage 118 that comprises piezo actuators and motors to provide both fine movement and coarse movement of the sample holder and sample. The control of the XYZ sample stage 118 is via a signal 119 from the controller 102 via the scan head 101.

The piezo and motor stages could be combined into a single stage located above the sample or within the sample stage.

The controller could comprise a field-programmable gate array (FPGA) and central processing unit (CPU) 114 and an analogue to digital converter (ADC) and digital to analogue converter (DAC) 115. Digital signal processors (DSPs) may also be included. Some or all of the processing may be done in the PC 103. The purpose of the controller is to calculate what signals shall be sent to the scan head 101 to facilitate the operation of the scan head in some defined manner. The FPGA and CPU can split the task of controlling the scan head. Typically the FPGA will perform the tasks that are time-critical and the CPU the tasks that are numerically intensive. The connection between the scan head and the controller 116 can be a number of wires. These wires carry either digital or analogue signals to control and detect the ion current, move the piezo and motor stages. For example, the piezo actuators can be controlled via an analogue signal and the coarse motors via digital signals.

The ion current can be established by a voltage generated within the controller being delivered to the IO section 105 and the electrode in the pipette 106, setting up an ion current through the sample electrolyte 112 back to the IO section 105 via the electrode 110. The generation of the ion current and the detection of the ion current could alternatively be in the scan head 101 or the PC 103.

FIG. 2 illustrates the raster scan hopping mode. In hopping mode the pipette 208 starts at some start position 201 at a location away from the sample 213. The controller via the scan head monitors the ion current that flows through the electrolytes in the pipette and the sample holder. At the start of the scan the pipette approaches 202 the surface of the sample at a controlled descent rate. The descent can be for example in small discrete steps, or can be a linear descent. As the pipette approaches the sample surface 203 the ion current starts to reduce. The controller halts the approach once the current has decreased by a pre-defined amount. The location for the pipette in the XYZ axes is recorded and then the pipette withdrawn 204 back to a safe height 201.

In a practical embodiment of an SICM system additional safeguards can be included in the design as follows. At the safe height 201 the XY stage may move to a new XY location, either as the start of a scan or as the next point in an on-going scan. The movement of the XY stages introduces momentum into the pipette and the motion stages that are attached to it or to the sample holder and the motion stages attached to that. Once the XY location is reached, the momentum of the moving masses will induce some oscillation as the motion stops. This oscillation generates noise in the scanned sample. As a consequence, a small pause or delay may be included at the top of the scan 201 to allow any resonances or vibrations of the pipette or sample holder to decay. The magnitude of the pause is of the order of a few ms, depending upon the mass of the pipette motion system or the sample holder motion system. The pipette motion system comprises all of the elements required to move the pipette (in X and/or Y and/or Z axis depending upon what motion is required) and the sample holder motion system comprises the sample holder and motion stages required to move the sample holder 211.

The descent or approach 202 to the sample can be at a controlled rate. If a high approach speed is commanded then there is a danger of either damaging the pipette tip or generating too much momentum in the pipette motion system. However, the lower the approach speed, the greater the time to complete a scan. The selection of the approach speed can be made through experimentation based on the pipette characteristics and the characteristics of the electrolyte solution 209 and 212. On reaching the surface 203 an additional pause or delay can be introduced to allow oscillations in the mechanical components of the pipette and sample holder to decay, and also variations in the ion current induced by the motion to stabilise.

A number of approaches to the surface can be made and either an average for the ion current taken, or the final value for the ion current taken. The objective is to reach the surface with an accurate estimation of the predefined ion current decrease but with a minimum of delay.

After the location of the surface 203 has been identified the pipette retracts 204. The rate of the retraction can be greater than the approach. The pipette can retract back to the safe height 201 before commencing second and subsequent approaches.

The first line of a raster scan can be made with a high safe height 201, but in subsequent scan lines a lower safe height selected based on acquired knowledge of the feature heights of the sample can be used. In this way, the total scan time can be reduced as the distance that the pipette has to travel will be reduced.

In summary, the typical operation of the raster scan hopping mode introduces delays and pauses, which increase the total scan time for the sample.

An example of a spreading, scrambling and modulation system is presented in FIG. 3. Instead of the usual DC, a spread spectrum modulated current is used to generate the ion current that passes through the electrolyte solution in the pipette and the sample holder.

The spread spectrum modulation scheme includes a spreading function 302, a scrambling function 303 and a filtering and modulation function 304. The combination of these entities will be referred to as the modulation system 306. The modulation system provides a method for generating multiple signals multiplexed in the time domain. The multiplexing could alternatively be in the frequency domain. In the frequency domain multiple independent frequency signals can be utilised or in the time domain, a time multiplexed signal can be utilised.

The inputs 301 to the modulation system 306 are at least one DC offset with a corresponding code number. The DC offset defines a DC level to be applied to a specific code channel appearing at the output 305 of the modulation system and the code number defines which of the spreading codes will be applied for a specific input.

The spreading codes can be generated from a family of orthogonal binary codes such as Walsh codes or Orthogonal Variable Spreading Factor codes. The specific codes selected and the length of the codes is defined by the code number. The controller is responsible for selecting which codes are used for the different channels.

Two codes can be used for a pure SICM application and three or more codes used for a combined SICM and SECM application. Alternate examples could use a single code for the pure SICM application and also the combined SICM and SECM application.

For the pure SICM application a short code can be selected alongside a long code. The length of the codes can be selected by the controller, with e.g. the short codes being 128 symbols and the long codes being 1024 symbols or longer. Different conditions and scan speeds may warrant the selection of different length codes. The short code can be used so as to track the height of the pipette above the sample surface and the long code used to image the details of the surface.

The scrambling codes are used to scramble the data symbols coming from the spreading system. The scrambling codes can be pseudo-random sequences such as Gold code sequences or m-sequences. The purpose of the scrambling codes is to randomise the structure of the spreading codes and regularise the resultant signal in the frequency domain.

The filtering and modulation stages 304 receive the spread and scrambled data symbols. The filtering may occur after the modulation. There are many choices for the modulation scheme to employ, e.g. binary phase shift keying (BPSK), quadrature phase shit keying (QPSK), n-quadrature amplitude modulation (n-QAM, where ‘n’ is an even integer specifying the order of modulation e.g. 4, 8, 16, 64), frequency modulation (FM), amplitude modulation (AM) etc. The input from the spreading and scrambling system is a polar signal that is used to modulate the phase of a signal. The spreading codes and the DC-levels affect the amplitude of the polar signal and hence the magnitude of the phase component coming from the modulator.

An IQ modulator can be used to generate a signal on a nominal carrier frequency. The benefit of adding a carrier frequency is that it can be used to move the modulated signal away from frequencies (e.g. DC to ˜100 Hz) on which a lot of noise and interference are expected to be present.

Filtering can follow the modulation. The filter can be a low pass filter removing unwanted high order components of the signal or it could be a high pass or band pass filter for removing respectively the low order frequencies or both. The filter can be implemented in the FPGA using FIR or IIR digital filters with filter characteristics such as Butterworth or Chebychev.

At the output 305 of the modulation system a signal is generated which is applied to the pipette electrode. The signal induces an ion current through the electrolyte solution which is monitored by the controller via the 10 system.

An example demodulator 406 is shown in FIG. 4. It comprises a number of blocks: a filtering function 402, an acquisition and de-scrambling function 403 and a correlator and de-spreading function 404. Alternative examples may exchange the order for the blocks, combine the blocks and even remove one or more of the blocks. The demodulator 406 can be implemented in the FPGA, the CPU, a DSP or the PC.

Input signals 401 arrive at the demodulator from one or more electrodes. The input signals are filtered using the filtering subsystem 402 to provide rejection of unwanted noise and interference. The filter could for example be a band pass filter that can reject low frequency noise and interference (e.g. at DC to 100 Hz) as well as high frequency noise and interference. The cut-off frequency and the rate of rejection can be selected to optimise the system behaviour, but may be different depending on whether a carrier signal is used by the modulation system. The filters can be implemented via digital filters or using other technologies such as switched capacitor filters, active filters or a number of different types of passive filters.

The filtered signal is passed to the acquisition and descrambling function 403. The acquisition system acquires and synchronises to the received signal, in a similar manner to the searches used in other spread spectrum systems. The de-scrambling system removes the scrambling code from the received signal. These functions can e.g. be implemented in the FPGA.

The output from descrambling function 403 is passed to the correlator and de-spreading block 404. The other inputs to the block are the DC levels and code numbers 407 similar to the DC levels and codes in the modulator subsystem. For the SICM only system there may be two codes, but no DC level. For the combined SICM/SECM system there may be three or more codes and different DC levels. Any DC level can be removed prior to the correlator/de-spreading block. The appropriate codes are applied to the correlator/de-spreading block such that the individual codes can be extracted from the composite received signal. A consequence of using orthogonal codes in the modulation system is that the signals extracted from the individual correlator/de-spreaders should be perfectly isolated. A single correlator/de-spreader can be used per code. Alternatively, a Rake receiver can be used to capture multiple delayed versions of the code-domain signal. The correlator/de-spreader 404 can be implemented in the FPGA.

The different signals 405 extracted from the demodulator can be passed to the CPU in the controller. Based on these signals, the controller can operate the approach, retraction, signal extraction and imaging from the sample.

In an example SICM system, the structure is similar to FIG. 1 with the modulation system and the demodulation system in the FPGA 114 in the controller 102.

In this example there is a single electrode 110 but an alternate example may include additional electrodes to separate the tracking code and the imaging code.

In a manner similar to the raster scan hopping mode, the pipette approaches the surface of the sample 113. The modulator subsystem applies two codes: a tracking code e.g. of length 128 symbols and an imaging code e.g. of length 1024 symbols. The codes can be selected from a family of variable length orthogonal codes such as the orthogonal variable spreading factor (OVSF) codes.

The demodulator is attached to either a single electrode 110 or two electrodes 110 depending on the configuration. In the single electrode case the demodulator extracts the two codes from the same signal. For the dual electrode configuration, two demodulators can be used, one per electrode, but with synchronisation between the demodulators.

The correlator/de-spreader reduces the bandwidth of the spread signal in direct proportion to the length of the code. This de-spreading reduces the effective bandwidth of the signal and hence improves the signal to noise ratio. For a 128 symbol tracking code, this is a factor of 128 improvement in the signal-to-noise ratio (SNR), or 21 dB expressed logarithmically, whilst the longer scanning code will improve the SNR by 1024 or 30 dB. Alternative examples with both longer and shorter codes can be envisaged based on the SNR that is present in practice based on experiment.

The shorter tracking code, when de-spread in the correlator, will produce a faster response for the ion current than the longer code, albeit at the expense of an increased noise floor due to the lower processing gain that is obtained from the shorter code.

The mechanism for detecting changes in the ion current can be based on either the direct changes in the ion current when referred to an approach curve or on changes in the differential current when referenced to an approach curve.

The controller utilises the de-spread signal obtained from the correlator in the demodulator to adjust the Z height of either the pipette 108 or the sample stage 118. The pipette may be moved for small adjustments and the sample stage for larger adjustments due to the pipette's lower mass.

An example output of the detected ion current from the tracking code is illustrated in FIG. 5 at 501, shown with the surface of sample 513 for comparison. A continuous change in Z for pipette 508 can be made for changes in XY as a line of the raster scan is made. Alternatively, step changes in Z can be made based on a number of samples from the de-spread tracking code.

The benefit of using the tracking code to control the z axis movement in this way, as compared to the raster scan hopping mode, is that discontinuous changes in direction are avoided and as a consequence the delays/pauses that were introduced to ameliorate the effects are no longer required. By smoothly tracking a safe height above the surface of the sample discontinuous jumps are avoided and as a consequence the vibrations and oscillations of the pipette motion stage and/or the sample motion stage are avoided. This significantly reduces the noise in the system and also speeds up the scanning time for the system.

With the tracking code used to manage the location of the pipette above the sample, the imaging code can be used to derive the image below the pipette. The imaging code is longer, takes more samples to correlate, but improves the SNR and hence the estimate of the height of the sample below the pipette.

The final stage of the imaging procedure is the de-convolution of the imaging signal to obtain an accurate response for the underlying topography of the sample. The imaging process can be a discrete time system with samples taken at least once per symbol. The rate at which the pipette is moving in the XY plane means that at a given XY location (within e.g. a +/−10 nm window) there are a finite number of samples of the imaging code. As the pipette moves laterally (and to a smaller extent vertically), the resultant detected image is a convolution of the actual image shape and the shape of the current collection envelope under the pipette. Typically the cross section of the current collection envelope is trapezoidal in shape with the smaller parallel side of the trapezoid being a diameter of the tip aperture of the pipette and the wider parallel side being close to the sample surface. The complete three dimensional (3D) shape for the current collection envelope is the trapezoidal shape rotated around the Z-axis of the pipette 180 degrees, i.e. a truncated cone. (The exact structure of the 3D current collection envelope can be defined from experimental measurements and calibration.)

With an assumption made for the shape of the 3D current collection envelope a de-convolution algorithm can be used to estimate the underlying image for the sample. There are many methods for 2D de-convolution of an image either with prior knowledge of the 3D current collection envelope or without (blind 2D de-convolution). For example various algorithms involving Wiener filters or linear predictive coding could be used. The 2D de-convolution can be implemented within the FPGA 114 of the controller.

An example approach curve is illustrated in FIG. 6A. The X axis defines the location of the pipette in microns from some arbitrary reference point. The Y axis shows the ion current through the pipette in nA. As the pipette approaches the sample, the ion current starts to fall. The surface of the sample can be seen in FIG. 6A as being somewhere in the region of 480 nm from the start point, i.e. where the current drops exponentially to zero.

FIG. 6B illustrates the same approach curve with an averaging factor of 128 as might be seen at the output of the tracking code correlator. In FIG. 6B, the current is normalised to 0 at the start of the approach and the last 128 samples are omitted due to there being insufficient data at the end to perform the averaging. What is clear from FIG. 6B is that the noise in the approach curve visible in FIG. 6A has been reduced.

An approach curve similar to that of FIG. 6B can be utilised as a reference for the surface detection obtained from the demodulator. Before the scan commences, a number of approach curves can be collected in regions around the sample and a composite approach curve made for a specific point.

Such a composite approach curve can be created from a linear combination of the approach curves from other points based on the linear distance from the curves. An expression for creating a composite approach curve for an arbitrary number of points around the sample is:

$$\frac{\frac{K 1}{\vert M 1 - P 1 \vert} + \frac{K 2}{\vert M 2 - P 2 \vert} + … \frac{K n}{\vert M n - Pn \vert}}{\frac{1}{\vert M 1 - P 1 \vert} + \frac{1}{\vert M 1 - P 2 \vert} + … \frac{1}{\vert M 1 - Pn \vert}} \qquad ( 1 )$$

wherein M1 (in XY coordinates) is the location for which the approach curve has to be calculated, P1, P2, Pn are the points for which the approach curve is known and K1, K2, Kn are the approach curve values. The metric |M1-P1| is the absolute value of the Euclidean distance between the points M1 and P1 in the XY plane.

Expression (1) makes a linear combination for the approach curve based on how far the measurement point (M1) is from a specific calibration approach curve (P1, P2 etc.). Care must be taken managing the asymptotes in the equation for the case when a measurement point is the same as the calibration point (i.e. M1=P1). This case should be handled separately to avoid the divide by zero problem on digital computers. In this case, the approach curve should be just K1. In the case when all points are equidistant from the measurement point (i.e. |M1−P1|=|M1−P2| . . . =|M1−Pn|, the composite approach curve should be the average of all the Kn calibration curves.

Alternative composite approach curves can be constructed, for instance by taking the square of the distance between the measured point and the calibration point. In fact any reasonable metric that extracts a composite approach curve from the calibration curves such that a smooth variation in the curves is obtained can be used.

In addition to the approach curves made before the scan, it is beneficial to also make additional approach curves during the scan. These additional approach curve points are based on locations within the current scan area. The number of additional approach curves made is controlled by the controller. Each additional approach curve will increase the total scan time, so a trade-off between total scan time and imaging resolution must be made.

Once the scan is complete, the system can estimate the approach curve characteristics at the same points as made during the scan. These final points can be used to account for wear that may have occurred in the pipette during the scan. The use of the post scan approach curves is for the imaging codes to obtain the most accurate estimation of the surface topology. It is an implementation decision as to whether the image is calculated using solely the pre-scan composite approach curve or subsequently corrected by including the post-scan approach curves.

There are a number of approaches for combining pre-scan, during-scan and post-scan approach curves, the simplest method is to use a time-delay weighting, e.g. a factor based on |t1−t2| can be used to weight a specific approach curve based on the time of the measurement (t1) and the time for each of the approach curves at the same point (t2) such that the calibration approach curve that is closest in time will have a larger weight than one further away in time. The exact form of the equation can vary, but could for example be very similar to (1) above, but using time difference as the metric rather than distance.

The system architecture for a combined SECM and SICM scan is defined with reference to FIG. 7 which is similar to FIG. 1, but with additional electrodes, e.g. 712. In this example there are two electrodes for the SICM system, 707 and 703, and one or more electrodes, e.g. 712 and 703, for the SECM system. For each electrode, there is a demodulator system.

In an alternative example, there may be multiple pipettes 702 connected in a manner that allows them to approach the surface together. One pipette can be allocated for the SICM topography and imaging and one or more pipettes allocated for the SECM measurements. In addition to the electrolyte 705 within the SECM electrode, additional coatings may be applied to the interior or exterior of the SECM pipette(s) to facilitate a specific electro-chemical effect that is being measured. In the example shown there is one electrode 712 per pipette, but alternative examples may utilise multiple electrodes per pipette. Each of the electrodes utilised can be attached to a separate demodulator subsystem.

Two codes can be allocated to the SICM system as described previously. For the SECM system one or more codes can be allocated; the allocation can be flexible. In some experiments multiple SECM codes per pipette may be required with a single or multiple electrodes 712.

All of the codes allocated can be selected from the same family of variable length orthogonal codes, such as the OVSF codes described previously. The length of the SECM codes can be selected based on the requirements for the measurement. Longer codes provide a more accurate estimation of current but increase the scan time, whilst shorter codes enable faster scanning but reduce the immunity to noise and interference that is introduced into the system. The length of the codes can be selected based on the experiment that is being conducted, but with the controller managing the allocation of the codes to ensure that orthogonality is preserved.

In addition to the code number (length and identity), a DC offset can be applied to the SECM system to induce additional electro-chemical effects. DC offsets can be applied per pipette 702. Each demodulator has knowledge of the DC offset applied to each pipette and is able to compensate for the DC offset in the demodulation process (e.g. by subtracting the magnitude of the DC component based on the measurements made in the acquisition system). In an alternative example, the DC offsets may be allowed to persist, and their magnitude and variation recorded for subsequent processing and evaluation.

In general, DC offsets will act as interference to the system. However, utilising the spreading and scrambling codes has the effect of attenuating the impact of the DC offset, provided the length of the codes is sufficient. The controller can be responsible for estimating the effects that the DC offsets may have on the system and either limiting their magnitude or informing the user via the PC that interference may cause impairments to the SECM measurements and/or the SICM imaging.

In summary, a system is described in which e.g. orthogonal spreading codes can be combined with scrambling codes. These codes allow multiple voltages and currents to be established through a SICM or SICM/SECM system in a manner that limits the interaction between the two.

In the SICM system multiple codes can be used; one for a range tracking loop (to adjust the pipette to stay at a relatively constant height above the sample) and a longer code that can more accurately measure the current through the pipette and via an approach curve calibration (e.g. stored in lookup tables) estimate the distance from the sample and hence the topology of the sample.

Multiple pipettes and multiple electrodes can be used in the system. The allocation of the codes to the pipettes and the electrodes is flexible and dependant on the specific effect that is being investigated. In this way SICM and SECM measurements can coexist with limited interference between the two.

The spreading and scrambling codes are inherently resistant to both noise and interference. A particularly severe form of interference is from the AC mains signal, typically 50 to 60 Hz. The system will allow either direct filtering of the compromised frequencies (e.g. DC to 100 Hz) to remove this, or using the interference rejection present within the codes, attenuate through the implicit action of the de-spreading and de-scrambling.

In addition, if the modulation of the signal is at a carrier frequency, the carrier centre frequency and bandwidth can be explicitly defined to avoid the low-end frequencies (e.g. DC to 100 Hz).

The use of the tracking code allows the pipette to smoothly follow the contours of the sample, whilst measuring the distance from the sample and adjusting the distance accordingly. This surface tracking reduces the needs to make discontinuous jumps in any of the X, Y, Z axes. The reduction in the discontinuities and hence the large changes to the momentum of both the pipette and the sample holder reduces the time that is required to allow the system to stabilise between measurements. The net consequence of this is that the scan speed can be increased, resulting in improvements in scan speed in excess of twenty times.

The potential blurring caused by the imaging codes imaging over distances greater than a single measurement pixel can be compensated for by using de-convolution techniques in either a 1D (per line) or a 2D mode.

A traditional raster scan hopping mode system makes a measurement of 128 by 128 pixels (measurement points) in 24 minutes. If we take this as a base line, we can calculate what the equivalent scan time will be for the example code lengths defined here, for a defined sample rate, or alternatively, what the scan time will be for codes of different lengths.

Assume a 128 symbol tracking code and a 1024 symbol imaging code. Normal scan time is typically 1,440 seconds over 16,384 pixels (approximately 88 ms per pixel on average, ignoring the possibility of spending more time on the first line). Assuming 100 ksamps/s, there are approximately 8,789 samples between pixels. Assuming that we want to have at least 4 tracking code lengths between pixels (i.e. 512 samples between pixels), we can increase the scan speed such that the total scan time reduces by a factor of 17, from 24 minutes to 84 seconds.

Alternatively, if we increase the sample frequency to 400 ksamps/s and maintain the same number of tracking code lengths between the pixels, the scan time is reduced by a factor of 69, and the total scan time reduces from 24 minutes to 21 seconds.

In both these cases, with an assumed imaging code of length 1024 symbols, the imaging codes will overlap two pixels and hence the requirement to use de-convolution to restore the original image. The imaging code could be reduced to 4 times the tracking code to prevent pixel overlap (this corresponds to 512 symbols) but this will be at the expense of reduced noise performance.

There is provided herein an example method for interrogating a surface using SICM, comprising the following steps:

(a) a controller generates an ion current that is modulated using a spread-spectrum modulation scheme e.g. based on the use of orthogonal spreading codes and/or pseudo-random scrambling codes;
(b) the controller moves close to the surface of the sample and records the ion current;
(c) the controller filters, de-spreads and de-scrambles the recorded ion current using one of a number of correlators to generate a narrow band representation of the ion current in the region of the sample;
(d) the controller then either directly from the ion current or from the difference in the ion current (current ion current sample minus previous ion current sample at a previous location) deduces the distance of the micropipette from the surface based on a stored version of the approach curve for the sample derived during a training period;
(e) a short correlator is used to generate location from the surface to provide a surface tracking signal;
(f) the surface tracking signal can be used to continuously adjust the height of the micropipette from the surface to be sufficiently high to avoid unexpected features, but sufficiently low to generate sufficient current variation to allow accurate height information to be collected;
(g) a second, longer correlator can be used to de-spread and de-scramble the recorded ion current (the longer correlator further reduces any noise in the ion current signal due to the larger processing gain that is available from the larger correlator);
(h) the approach curve is again used to convert the measured ion current in to an estimate of the height from the surface of the sample.

De-convolution algorithms can be used in the controller to remove some of the image blurring caused by the movement of the micropipette whilst the ion current is being collected.

Multiple orthogonal spreading codes can be assigned in the system to allow the multiple ion current flows to be collected simultaneously as per the following steps:

(a) the SICM topology imaging system is assigned an orthogonal spreading code of length suitable for the surface tracking;
(b) the SICM topology imaging system is assigned an orthogonal spreading code of length suitable for the 3D imaging of the surface;
(c) the SECM measurement system is assigned an orthogonal spreading code of length suitable for the detection of the ion currents for the SECM system;
(d) the controller generates and collects the different spread spectrum modulated current signals (the signal path for the signals does not need to be the same, but all could use the same micropipette for simplicity of deployment);
(e) additional electrodes immersed in the electrolyte in the sample container can be used (e.g. the SICM electrodes and SECM electrodes can be different and the subsequent ion currents passed to the controller via two different input connectors;
(f) the two different SICM orthogonal codes may be collected via different electrodes immersed within the electrolyte in the sample container;
(g) additional orthogonal spreading codes of suitable length can be utilised for the collection of additional ion current flows for the SICM, SECM or other applications in which an independent measure of ion current is required.

Further improvements have also been developed for when the SICM system operates in AC mode.

There is described herein a method for interrogating a surface using SICM, comprising the following steps:

(a) a controller generates an AC Z-pipette modulation current that varies the location of the pipette above the surface, the frequency of the modulating signal being beyond the natural resonant frequency of the pipette and the piezo flexure stage.;
(b) the controller moves the z-axis pipette close to the surface of the sample and records the detected ion current;
(c) the controller implements a lock-in amplifier and filters and amplifies the detected current;
(d) the controller uses the detected ion current to modulate the location of the Z sample stage to ensure that the location of the pipette from the sample remains approximately constant.

FIG. 8 illustrates the raster scan AC mode. In an example AC mode, the pipette 808 starts at some start position 801 at a location away from the sample 813. AC modulation of the Z-axis location 802 of the pipette is applied by the controller to the Z-axis pipette actuator. As the pipette approaches the surface of the sample, the AC modulation of the pipette induces an AC modulation of the ion current.

The ion current is passed via the scan head to the controller where it is digitised via an ADC. The digital signals can then be passed to the FPGA/CPU that can implement a lock-in amplifier in which the frequency of the AC signal is used to filter and amplify the wanted AC component, but also reject any noise outside of the bandwidth of interest.

The AC modulated ion current is passed to a complex envelope detector that detects the magnitude and phase of the AC ion current. The magnitude of the complex envelope of the ion current is used to identify the presence of the surface of the sample, optionally using approach curve data to improve the accuracy.

As the pipette approaches the surface, the mean distance from the sample can be adjusted by adding a DC level to the AC modulating voltage that is driving the Z-axis pipette piezo actuator in order to keep the pipette at a constant distance from the sample. The scanning time performance of the system is generally limited by the modulation frequency of the Z-axis pipette. In the prior art, these modulation frequencies are typically below the resonant frequency of the Z-axis pipette actuator and in the region of 1-2 kHz.

In addition to the use of the AC mode modulation to detect the surface, the surface can be scanned in a raster scan mode which in essence forces the pipette to traverse in the X axis direction of the surface, making measurements at appropriate pixel locations before incrementing the Y axis position and repeating the X axis scan. The next Y position may be immediately above the previous Y position (i.e. the X position remains the same), or in an alternative example each line may be started at the same start X coordinate each time (e.g. X=0). A slow scan may be performed for the first line of the scan to estimate the major topographic features, and based on that initial starting point, faster scans may be performed whilst updating the record for the topographical profile of the sample.

Considering a model of the Z-axis pipette and actuator as being a second order resonant system and applying an AC mode modulation to the pipette and actuator and recording the amplitude variation of the pipette, something similar to the waveforms shown in FIG. 9 is observed. The transient start-up of the system is closely followed by a move into a steady-state performance. The amplitude of the pipette is shown in Volts (as measured by the servo system). The time axis in the figure has been normalised such that the resonant frequency is 1 Hz. In a real system, the actual resonant frequency would be closer to 3 kHz.

It is recognised herein that the frequency of the AC modulation can be above that of the resonant frequency of the Z-axis pipette and piezo actuator.

FIG. 10A shows the response of the system to an applied AC modulation frequency 20 times that of the resonant frequency (20 Hz in the example, but closer to 60 kHz in practice). The initial transients in the figure occur at a rate that is related to the resonant frequency of the system, but over time these transients decay to a steady state value.

Turning to FIG. 10B, which shows later times, the amplitude of the Z-axis pipette approaches a steady state condition and the peak modulation amplitude (of the complex envelope) becomes constant. It should be noted that the maximum amplitude of the modulation of the Z-axis pipette is reduced, in this example, by a factor of about one thousand due to the attenuation introduced by the second order system. This reduction in amplitude is not an issue since we only require small deviations in the Z-axis motion.

The amplitude of the high frequency AC modulation can be slowly increased to prevent the transients visible in FIG. 10A from causing undue damage to the pipette. The shape of the ramp is not necessarily linear, it can be gradual, e.g. the inverse of the complex envelope of the resonances in the Z-axis pipette piezo actuator. With reference to FIG. 10A, the ramp would start at a low value at time=0 and rise to its maximum steady state value at a time in the region of 8 seconds. It should be noted that FIG. 10 has been normalised, and the actual time and amplitude values will depend upon the exact values of the Z-axis pipette piezo actuator resonant frequency and the frequency of AC modulation signal. (With a resonance of around 3 kHz, the ramp duration could be e.g. around 3 ms.)

The measured AC modulated ion current is passed to the FPGA/CPU where a lock-in amplifier can provide noise and interference rejection and a complex envelope detection process is implemented, by which means the amplitude and phase of the ion current can be extracted.

The magnitude of the measured ion current complex envelope, when combined with an approach curve calibration technique, provides an accurate estimate for the location of the pipette from the sample surface.

To keep the pipette at a defined location above the sample surface, the distance between the sample and the pipette must be adjusted. However, additional variation in the height of the Z-axis pipette can potentially cause instabilities in the overdriven second order system. Accordingly, an alternative to varying the mean value of the modulating signal may be preferred.

To provide changes to the pipette-sample distance, the magnitude of the complex envelope of the ion current can be used to modulate the drive signal to the Z-sample stage piezo actuator. So, for example, as the ion-current falls below some set-point, it is deemed that the pipette is getting too close to the sample and the voltage to the Z-sample stage piezo actuator is adjusted (e.g. based on the approach curve calibration technique) to maintain a constant and known distance from the sample. Equivalently, as the ion-current increases, the voltage is adjusted to decrease the distance between the pipette and the sample. The relationship between the detected ion current and the applied voltage correction can be linear with some constant of proportionality determined either through a calibration step or fixed for each particular electrolyte solution.

The oscillatory modes of the Z-axis actuator and pipette system can be measured and hence characterised, and based on this modal analysis a driving signal can be defined that induces the correct AC mode current as well as the appropriate variation for the mean of the AC signal. An appropriate drive signal that maintains stability can be derived by analysis of the overall system in terms of its eigenvectors/eigenvalues. The analysis and synthesis stages can be performed in the FPGA/CPU within the controller.

In this context, 501 in FIG. 5 can be considered to be a typical trajectory that the Z-sample stage piezo might take as the pipette moves across the surface. An observable feature of the Z-sample stage signal is that the rate of variation in the drive signal is much lower than that of the Z-pipette piezo and, as a consequence, the bandwidth of the drive signal for the Z-sample stage piezo is lower than the resonant frequency of the Z-axis sample stage actuator.

Assume a raster scan is performed based on a number of measurement points (pixels). As an example, consider a scan of an area of 32×32 pixels. Making an assumption that ion-current samples can be taken at the rate of the AC mode modulation frequency (e.g. in the region of 60 kHz) with the lock-in amplifier (e.g. implemented in the FPGA/CPU) filtering out the noise and interference and delivering a stable sample for the ion-current, the time taken to perform the complete scan is in the region of 17 ms. Either a static average (X or Y in a stepped raster scan) or a moving average (X or Y in a continuously moving raster scan) can be taken. For example, six samples of the magnitude of the ion current can be taken and averaged, in which case the total scan time is reduced to around 100 ms. It should be noted that some additional time is required to raise the pipette at the end of each line, and move to the start of the next line, but this additional time factor is small and will not impact the overall performance significantly.

As a comparison, this scan time is approximately twenty times faster than a system in which the frequency of the AC mode modulation is close to the resonant frequency of the Z-axis pipette piezo actuator.

A Z-axis pipette piezo actuator with a travel range in the region of 100 μm can be used. The attenuation of the displacement due to the over-driving of the AC modulation signal results in a reduction of the order of one thousand in the amplitude if a frequency twenty times greater than the resonant frequency of the actuator is used. This results in a Z-axis AC modulation amplitude in the region of 100 nm, which is suitable for generating the AC modulated ion-current.

In summary a system is described in which a Z-axis pipette piezo actuator and a Z-axis sample piezo actuator are used to allow a pipette to track and measure the topography of the surface of a sample. The Z-axis pipette piezo actuator is used to induce a stable modulation of the pipette at a frequency above the resonant frequency of the actuator (e.g. over 20 times the resonant frequency) using an AC modulated voltage produced by the controller. An ion current modulation is induced when the pipette is close to the sample, with the frequency of the modulated current equal to that of the pipette AC modulation. A lock-in amplifier tuned to the high frequency AC modulation is used to filter out unwanted noise and interference. The AC modulated ion current is passed to a complex envelope detector in the controller which extracts the magnitude of the complex envelope of the ion current. The Z-axis sample piezo actuator position is used to track the surface of the sample using the magnitude of the envelope of the ion current as the drive voltage. The speed of a raster scan is improved due to the increase in speed of the Z-axis pipette piezo. Approach curve calibrations are used to improve on the accuracy of the topographical estimation. Scanning time increases by a factor of over 20 are feasible, with a 32×32 pixel image being scanned in the region of 100 ms.

Other embodiments will be apparent to those skilled in the art from consideration of the specification and practice of the embodiments disclosed herein. It is intended that the specification and examples be considered as exemplary only.

In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

1. A method for interrogating a surface of a sample bathed in an electrolyte solution using scanning ion conductance microscopy (SICM), comprising:
controlling the potential between first and second electrodes bathed in the electrolyte solution to induce an ion current in the electrolyte solution using a spread spectrum modulated signal, a submerged portion of the first electrode being contained within a micropipette and the second electrode being external to the micropipette;
recording the ion current whilst controlling the micropipette to move with respect to a stage supporting the sample;
demodulating the recorded ion current; and
determining, from the demodulated ion current and calibration data, the surface height profile of the sample.

2. The method of claim 1, wherein said spread spectrum modulation comprises multiplexing a plurality of signals in the time or frequency domain.

3. The method of claim 1, wherein said spread spectrum modulation is carried out by one of: binary phase shift keying (BPSK), quadrature phase shift keying (QPSK), n-quadrature amplitude modulation (n-QAM), frequency modulation (FM) or amplitude modulation (AM).

4. The method of claim 1, wherein said spread spectrum modulation is performed on a predetermined carrier frequency, said carrier frequency optionally being greater than 100 Hz.

5. The method of claim 1, wherein said spread spectrum modulation is performed using (i) orthogonal spreading codes, optionally Walsh codes or orthogonal variable spreading factor (OVSF) codes, (ii) 2 or 3 different spreading codes, or (iii) pseudo-random scrambling codes, optionally Gold code sequences of m-sequences.

6-7. (canceled)

8. The method of claim 1, further comprising filtering the recorded ion current, optionally using a band pass filter.

9. The method of claim 1, further comprising feeding back surface height profile data in order to control said micropipette motion to track the sample surface.

10. The method of claim 9, wherein a surface tracking signal is provided using a short correlator.

11. The method of claim 9, wherein said spread spectrum modulation is performed using at least a first spreading code for surface tracking and a second spreading code for imaging, said second code being longer than said first code.

12. The method of claim 1, wherein said demodulation is performed using a long correlator.

13. The method of claim 1, further comprising executing a de-convolution algorithm to reduce image blurring caused by micropipette movement.

14. The method of claim 1, wherein said determination comprises deconvolving the demodulated ion current with a truncated cone having the sample surface as its base and the micropipette aperture as its top.

15. The method of claim 1, further comprising collecting data from a third electrode for scanning electrochemical microscopy (SECM).

16. The method of claim 15, further comprising applying a direct current (DC) offset voltage to said third electrode relative to said first electrode.

17. The method of claim 1, wherein a first piezoelectric actuator is used for relatively fine z-axis motion control of the micropipette and a second piezoelectric actuator is used for relatively coarse z-axis motion control of the sample stage.

18. The method of claim 1, wherein said micropipette motion is according to (i) a hopping mode pattern or (ii) an alternating current (AC) mode pattern.

19. (canceled)

20. The method of claim 18, wherein said AC mode pattern has a modulation frequency greater than a resonant frequency of an assembly of the micropipette, first electrode and a first piezoelectric actuator configured to control z-axis motion of said micropipette.

21. A method for interrogating a surface of a sample bathed in electrolyte solution using AC mode scanning ion conductance microscopy (SICM), comprising:
controlling a first piezoelectric actuator to vary the height of a micropipette containing a portion of a first electrode submerged in the electrolyte solution relative to a stage supporting the sample,
using an alternating current (AC) of modulation frequency greater than the resonant frequency of an assembly of the actuator, micropipette and first electrode, in order to induce an ion current in the electrolyte solution between said first electrode and a second electrode external to the micropipette and bathed in the electrolyte solution;
recording the ion current whilst controlling the micropipette to move with respect to the sample stage, said motion having a component perpendicular to the AC height variation; and
determining, from the recorded ion current and calibration data, the surface height profile of the sample.

22. The method of claim 21, wherein said AC modulation frequency is at least 20 times said resonant frequency.

23. The method of claim 21, wherein said AC modulation frequency is approximately 60 kHz.

24. The method of claim 21, wherein, prior to said recording, said AC mode motion is switched on with an initial AC frequency lower than said AC modulation frequency, which is gradually turned up to said AC modulation frequency over a predetermined period of time according to a ramp function.

25. The method of claim 24, wherein said ramp function is the inverse of a complex envelope of resonances of said assembly.

26. The method of claim 24, wherein said predetermined period is approximately 3 ms.

27. The method of claim 21, further comprising driving a second piezoelectric actuator to control z-axis motion of said sample stage according to a signal modulated by the magnitude of a complex envelope of the recorded ion current.

28. The method of claim 21, wherein a voltage correction is applied to a second piezoelectric actuator configured to control z-axis motion of said sample stage, said voltage correction scaling linearly with the detected ion current.

29. The method of claim 28, wherein a constant of proportionality for said scaling is determined through a calibration process and/or from a predetermined constant associated with the electrolyte solution.

30. The method of claim 21, wherein the bandwidth of a drive signal for a second piezoelectric actuator configured to control z-axis motion of said sample stage is less than the resonant frequency of an assembly of said second piezoelectric actuator with the micropipette, sample stage, sample container, electrolyte and sample.

31. The method of claim 21, further comprising controlling the potential between said first and second electrodes using a spread spectrum modulated signal;
wherein said determining comprises demodulating the recorded ion current.

32. The method of claim 31, wherein said spread spectrum modulation comprises multiplexing a plurality of signals in the time or frequency domain.

33. The method of claim 31, wherein said spread spectrum modulation is carried out by one of: binary phase shift keying (BPSK), quadrature phase shift keying (QPSK), n-quadrature amplitude modulation (n-QAM), frequency modulation (FM) or amplitude modulation (AM).

34. The method of claim 31, wherein said spread spectrum modulation is performed on a predetermined carrier frequency, said carrier frequency optionally being greater than 100 Hz.

35. The method of claim 31, wherein said spread spectrum modulation is performed using (i) orthogonal spreading codes, optionally Walsh codes or orthogonal variable spreading factor (OVSF) codes, (ii) 2 or 3 different spreading codes, or (iii) pseudo-random scrambling codes, optionally Gold code sequences of m-sequences

36-37. (canceled)

38. The method of claim 31, further comprising filtering the recorded ion current, optionally using a band pass filter.

39. The method of claim 31, further comprising feeding back surface height profile data in order to control said micropipette motion to track the sample surface.

40. The method of claim 39, wherein a surface tracking signal is provided using a short correlator.

41. The method of claim 39, wherein said spread spectrum modulation is performed using at least a first spreading code for surface tracking and a second spreading code for imaging, said second code being longer than said first code.

42. The method of claim 31, wherein said demodulation is performed using a long correlator.

43. The method of claim 31, further comprising executing a de-convolution algorithm to reduce image blurring caused by micropipette movement.

44. The method of claim 31, wherein said determination comprises deconvolving the demodulated ion current with a truncated cone having the sample surface as its base and the micropipette aperture as its top.

45. The method of claim 31, further comprising collecting data from a third electrode for scanning electrochemical microscopy (SECM).

46. The method of claim 45, further comprising applying a direct current (DC) offset voltage to said third electrode relative to said first electrode.

47. The method of claim 31, wherein the first piezoelectric actuator is used for relatively fine z-axis motion control of the micropipette and a second piezoelectric actuator is used for relatively coarse z-axis motion control of the sample stage.

48. The method of claim 1, wherein said calibration data comprises a composite approach curve for each XY location at which the ion current is recorded, said composite approach curves being determined from a plurality of calibration approach curves measured during a training sequence.

49. The method of claim 48, wherein said composite approach curves are linear combinations of said plurality of calibration curves weighted according to the linear distances of said respective XY locations from the XY locations of said plurality of calibration curves.

50. The method of claim 48, wherein said plurality of calibration curves are collected prior to and/or during and/or after said step of recording the ion current whilst controlling the micropipette to move with respect to the sample stage.
